(19) United States
(12) Patent Application Publication
(10) Pub. No.: US 2025/0264788 A1
(43) Pub. Date: Aug. 21, 2025

(54) Light Projector and Light Bar Assembly

(71) Applicant: ITC Inc., Hudsonville, MI (US)

(72) Inventors: Scott Meyers, Holland, MI (US); Steve Hoek, Holland, MI (US); Jon Rathbun, Belmont, MI (US); Jason Mulder, Hudsonville, MI (US)

(21) Appl. No.: 19/201,003

(22) Filed: May 7, 2025

Related U.S. Application Data
(63) Continuation-in-part of application No. 19/012,360, filed on Jan. 7, 2025.
Application No. 19/012,360 is a continuation of application No. 17/972,209, filed on Oct. 24, 2022, now Pat. No. 12,210,275.
(60) Provisional application No. 63/271,395, filed on Oct. 25, 2021.
(60) Provisional application No. 63/570,347, filed on Mar. 27, 2024.
(60) Provisional application No. 63/777,908, filed on Mar. 26, 2025.
(60) Provisional application No. 63/643,543, filed on May 7, 2024.
(60) Provisional application No. 63/648,852, filed on May 17, 2024.

(51) Int. Cl. G03B 21/20; B60Q 1/26; G03B 21/14

(52) U.S. Cl. CPC G03B 21/2006; G03B 21/145; B60Q 1/2619

(57) ABSTRACT

A light assembly having a projector integrally connected to a light bar. The projector and the light bar share power and control wires from a wire harness. The projector includes a projector aperture whereby light (oftentimes in a pattern or logo formation) passes therethrough and directs onto a ground surface. The projector includes a light assembly configured to hold the components for projection.

### CROSS REFERENCE TO RELATED APPLICATIONS

This application is a continuation-in-part application of U.S. Ser. No. 19/012,360 filed Jan. 7, 2025, which is a continuation application from U.S. Ser. No. 17/972,209, filed Oct. 24, 2022 which claims priority and benefit to Provisional Patent Application Ser. No. 63/271,395 filed on Oct. 25, 2021, the application also claims priority to U.S. Provisional Application Ser. No. 63/570,347, filed Mar. 27, 2024, U.S. Provisional Application Ser. No. 63/777,908 filed on Mar. 26, 2025, U.S. Provisional Application Ser. No. 63/643,543 filed on May 7, 2024, and U.S. Provisional Application Ser. No. 63/648,852 filed on May 17, 2024.

### TECHNICAL FIELD

The present specification generally relates to light assemblies for vehicles and, more specifically, a light projector for projecting light patterns onto the ground from a vehicle wherein said projector is integrated with a light bar and connection members thereof.

### BACKGROUND

It is well known in the art to equip vehicles with welcome lights or projector lights which project light, patterns and/or logos onto the ground. Light bars to illuminate the ground are also known. However, it is always desirable to reduce the number of parts in a vehicle to reduce cost, number of parts, and weight. Furthermore, it is often desirable to add a projector to an already existing vehicle.

It is well known in the art to equip vehicles with welcome lights or projector lights which project light, patterns and/or logos onto the ground. Light bars to illuminate the ground are also known. However, it is always desirable to reduce the number of parts in a vehicle to reduce cost, number of parts, and weight. Furthermore, it is often desirable to add a projector to an already existing vehicle.

Light bars are commonly used on vehicles designed to provide additional illumination, functionality, and visual appeal. While such configurations have proven effective in certain applications, there remains a need for a lighting system that can be positioned on the underside of a vehicle with additional or improved attachment means offering unique advantages in terms of functionality and design.

Accordingly, there exists a need in the art to provide an improved projector overcoming the aforementioned disadvantages.

### SUMMARY

A light assembly having a projector integrally connected to a light bar. The projector and the light bar share power and control wires from a wire harness. The projector includes a projector aperture whereby light (oftentimes in a pattern or logo formation) passes therethrough and directs onto a ground surface. The projector includes a light assembly configured to hold the components for projection.

A light projector assembly having a projector integrally connected to a light bar, the projector and the light bar sharing power and control wires from a wire harness, the projector having a projector aperture whereby light passes therethrough and directs onto a ground surface, the projector includes a light assembly configured to hold the components for projection, the light assembly being clear allowing light to pass therethrough, and the light assembly being sealed so as to protect the projector and lens components wherein the lens components are sealed within the light assembly, a first power source wire is soldered directly to a printed circuit board in a projector housing, a second power source wire soldered to the printed circuit board and extending to the light bar, wherein reducing wires and providing for a pass-through power configuration reduces parts and thus cost to the vehicle.

In some embodiments, the light components includes a lens stack. The lens stack may have minimized or reduced heights size and include a customizable image slide wherein the customizable image slide enables customization with preferred logos and/or patterns for projection onto a ground surface. In some embodiments, a cover is configured to house and cover the light assembly. In some embodiments, the lens stack comprises a collimation lens set, an image slide, and a zoom and aberration lens set. In some embodiments, the cover includes an endcap and covers a front portion of the light assembly. The first cover may connect to the second cover and covers a rear portion of the light assembly. In some embodiments, the endcaps cover both the first section and the second section of the cover so as to retain the light assembly onto the end of the light bar. Potting material may be used inside of the cover to seal from external environmental conditions.

A light projector assembly having a projector integrally connected to a light bar, the projector and the light bar sharing power and control wires from a wire harness, the projector having a projector aperture whereby light passes therethrough and directs onto a ground surface, the projector includes a light assembly configured to hold the components for projection, a lens stack, the lens stack including a collimation lens set, an image slide, and a zoom and aberration lens set, and the light assembly being sealed so as to protect the projector and lens components wherein the lens components are sealed within the light assembly, wherein reducing wires and providing for a pass-through power configuration reduces parts and thus cost to the vehicle.

In some embodiments, the cover includes an endcap and covers a front portion of the light assembly. In some embodiments, the first cover connects to the second cover and covers a rear portion of the light assembly. In other embodiments, the endcaps cover both the first section and the second section of the cover so as to retain the light assembly onto the end of the light bar. Potting material may be used inside of the cover to seal from external environmental conditions. In some embodiments, a first power source wire is soldered directly to a printed circuit board in a projector housing, a second power source wire soldered to the printed circuit board and extending to the light bar.

A light assembly having a projector integrally connected to a light bar. The projector and the light bar share power and control wires from a wire harness. The projector includes a projector aperture whereby light (oftentimes in a pattern or logo formation) passes therethrough and directs onto a ground surface. The projector includes a light assembly configured to hold the components for projection.

A light projector assembly having a projector integrally connected to a light bar, the projector and the light bar sharing power and control wires from a wire harness, the projector having a projector aperture whereby light passes therethrough and directs onto a ground surface, the projector includes a light assembly configured to hold the components for projection, the light assembly being clear allowing light to pass therethrough, and the light assembly being sealed so as to protect the projector and lens components wherein the lends components are sealed within the light assembly, wherein reducing wires and providing for a pass-through power configuration reduces parts and thus cost to the vehicle. The light components may have a lens stack. The lens stack may have a minimized or reduced heights size and include a customizable image slide wherein the customizable image slide enables customization with preferred logos and/or patterns for projection onto a ground surface. A cover is may be configured to house and cover the light assembly. In some embodiments, a cover is a two-shell piece design: a first section and a second section. The cover may include an endcap and covers a front portion of the light assembly. The first cover may connect to the second cover and covers a rear portion of the light assembly. The endcaps may cover both the first section and the second section of the cover so as to retain the light assembly onto the end of the light bar. In some embodiments, potting material is used inside of the cover to seal from external environmental conditions.

A light projector assembly having a projector integrally connected to a light bar, the projector and the light bar sharing power and control wires from a wire harness; the projector having a projector aperture whereby light passes therethrough and directs onto a ground surface, the projector includes a light assembly configured to hold the components for projection, a split shell cover, the cover having a first portion and a second portion, and the light assembly being sealed so as to protect the projector and lens components wherein the lends components are sealed within the light assembly, wherein reducing wires and providing for a pass-through power configuration reduces parts and thus cost to the vehicle. The cover may include an endcap and covers a front portion of the light assembly. The first cover may connect to the second cover and covers a rear portion of the light assembly. The endcaps may cover both the first section and the second section of the cover so as to retain the light assembly onto the end of the light bar. In some embodiments, potting material is used inside of the cover to seal from external environmental conditions.

In other embodiments, the light bar assembly includes a spring finger that presses against the logo holder and a set screw allows for adjustment. A locking wedge may be provided for securement. In alternative configurations, the light bar assembly features a spring-loaded finger exerting pressure on the logo holder, with a set screw enabling fine adjustments. Additionally, a locking wedge could be incorporated for enhanced stability.

In yet another embodiment, a more universal part is provided having a plurality of vehicle mounting holes. An angle adjustment plate allows for fine tuning. An adjustable attachment item is provided connected to a logo clear housing and the adjustable face plate. A heat sink function is also provided which may be metal to protect from rock strikes.

In yet another embodiment, the innovation extends to a more versatile component designed to cater to a wider array of vehicle models, featuring a comprehensive array of mounting options with a plurality of vehicle-specific mounting holes. This design accommodates various vehicle types and configurations, ensuring compatibility and ease of installation across different makes and models.

Enhancing its adaptability further, an angle adjustment plate is integrated, offering precise fine-tuning capabilities. This feature allows for optimal positioning of the light bar assembly, enabling users to customize the angle according to their specific requirements and preferences, whether for aesthetic appeal or functional performance.

Moreover, to facilitate seamless attachment and alignment, an adjustable attachment mechanism is introduced. This mechanism serves as a pivotal link between the logo clear housing and the adjustable face plate, providing a secure and adjustable connection that simplifies installation and ensures proper alignment of components.

Recognizing the importance of durability and resilience, particularly in rugged terrain or off-road environments, a heat sink function is incorporated into the design. Constructed from robust metal materials, this heat sink serves a dual purpose, dissipating excess heat generated by the light bar assembly while also offering protection against potential damage from rock strikes or other external impacts. By fortifying the assembly with this heat sink feature, the longevity and reliability of the light bar assembly are significantly enhanced, ensuring optimal performance even in challenging conditions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, light projector assembly may include a projector having a longitudinal axis, where the projector is configured to rotatably couple to the light bar via an attachment item. Light projector assembly may also include the projector being configured to rotate. Assembly may furthermore include the projector having a projector aperture where light passes therethrough and directs onto a ground surface. Assembly may in addition include the projector being configured to receive a light housing, where the light housing is rotatably coupled to the projector. Assembly may moreover include the light housing being configured to rotate around an axis perpendicular and/or parallel to the longitudinal axis (see arrows 401, 403 of FIG. 17) of the projector, where the light housing may be locked in a desired position relative to the projector via at least one locking mechanism. Assembly may also include the light housing having lens components, where the light housing is sealed so as to protect the projector and the lens components. Assembly may furthermore include the light housing being clear allowing light to pass therethrough. Other embodiments of this aspect include corresponding computer systems, apparatus, and computer programs recorded on one or more computer storage devices, each configured to perform the actions of the methods.

Implementations may include one or more of the following features. Light projector assembly may include a light bar. Light projector assembly where the projector and the light bar share power and control wires from a wire harness. Light projector assembly where the at least one locking mechanism may be a set screw, a locking wedge, a locking wedge with teeth, an angle wedge, a flat wedge, and/or a spring. Light projector assembly having two locking mechanisms. Light projector assembly having three locking mechanisms. Light projector assembly where the attachment item is a bracket, a crimp, and/or a clamp. Light projector assembly where the lens components may include a collimation lens set, a zoom and aberration lens set, and/or an image slide with a preferred logo and/or pattern for projection onto a ground surface. Implementations of the described techniques may include hardware, a method or process, or a computer tangible medium.

In one general aspect, connection assembly may include a grommet configured to be partially received in an opening of a vehicle metal body of a vehicle. Connection assembly may also include a light bar wire configured to be received within the grommet. Assembly may furthermore include a tether configured to couple the light bar wire to the vehicle metal body of the vehicle. Other embodiments of this aspect include corresponding computer systems, apparatus, and computer programs recorded on one or more computer storage devices, each configured to perform the actions of the methods.

Implementations may include one or more of the following features. Connection assembly where the grommet may include a first portion partially received within the opening of the vehicle metal body of the vehicle, a second portion connected to the first portion and having a second longitudinal axis at an angle of approximately 45 degrees relative to the vehicle metal body, and a third portion connected to the second portion and having a third longitudinal axis substantially parallel to the vehicle metal body. Connection assembly where a first portion of the light bar wire extends along the first longitudinal axis of the grommet, a second portion of the light bar wire extends along the second longitudinal axis of the grommet, and a third portion of the light bar wire extends along the third longitudinal axis of the grommet. Connection assembly where the tether may include: a circular portion positioned around the first portion of the light bar wire and configured to connect to the first portion of the light bar wire; and at least one arm configured to connect to the first portion of the light bar wire, the circular portion, and the vehicle metal body. Connection assembly where the first portion of the light bar wire may include at least one extension arm extending away from the first longitudinal axis of the grommet. Connection assembly where the tether may include: an interference portion positioned around the first portion of the light bar wire and having at least one opening around the circumference of the interference portion; at least one arm configured to connect to the interference portion and the vehicle metal body; and where the at least one extension arm extends through the at least one opening in the interference portion to prevent movement of the interference portion relative to the vehicle metal body along the first longitudinal axis of the grommet. Connection assembly where the tether may include: a connector portion positioned around the first portion of the light bar wire and configured to connect to the first portion of the light bar wire via at least one intermediate arm; and at least one arm configured to connect to the first portion of the light bar wire, the connector portion, and the vehicle metal body. Connection assembly where the tether may include: a sheath portion configured to be received in the grommet and positioned around the first, second, and third portions of the light bar wire and configured to connect to the first, second, and third portions of the light bar wire via at least one intermediate arm; and at least one arm configured to connect to the sheath portion and the vehicle metal body.

In one general aspect, low-profile light assembly may include a pinch flange of a vehicle extending linearly between the fore and aft of the vehicle; a light housing coupled to the vehicle metal body directly adjacent to the pinch flange and configured to direct light in the fore and aft directions, where the first light housing is located between the pinch flange and a centerline of the vehicle (or directly adjacent to the pinch flange and between the pinch flange and the outer perimeter of the vehicle); where the first light housing is hidden from view of an user outside of the vehicle. Other embodiments of this aspect include corresponding computer systems, apparatus, and computer programs recorded on one or more computer storage devices, each configured to perform the actions of the methods.

In one general aspect, low-profile light assembly may include The low-profile light assembly. Other embodiments of this aspect include corresponding computer systems, apparatus, and computer programs recorded on one or more computer storage devices, each configured to perform the actions of the methods.

In one general aspect, low-profile light assembly may include. The low-profile light assembly. Other embodiments of this aspect include corresponding computer systems, apparatus, and computer programs recorded on one or more computer storage devices, each configured to perform the actions of the methods.

Implementations may include one or more of the following features. Low-profile light assembly where the attachment piece is a wingnut, a bolt, a clip, and/or a tether. Implementations of the described techniques may include hardware, a method or process, or a computer tangible medium.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, low-profile light assembly may include a pinch flange/body sheet metal of a vehicle extending linearly between the fore and aft of the vehicle; a light housing coupled to the pinch flange vehicle undercarriage and directly adjacent to the pinch flange, and the light housing configured to direct light in the fore and aft directions, where the first light housing is located between the pinch flange and a centerline of the vehicle; OR outboard of the pinch flange (the idea is that the lamp can be mounted anywhere on the undercarriage, either inboard or outboard of the pinch flange as needed. where the first light housing is hidden from view of an user outside of the vehicle. Other embodiments of this aspect include corresponding computer systems, apparatus, and computer programs recorded on one or more computer storage devices, each configured to perform the actions of the methods.

In one general aspect, light bar may include a light bar. Light bar may also include a projector integrated within the light bar. Bar may furthermore include at least one bracket for supporting the light bar, the bracket being connected to the light bar through pre-formed holes. Bar may in addition include a wire or wire harness connected to the projector and to the light bar for supplying power and signals. Bar may moreover include the projector including at least one mirror or reflector positioned at an angle to direct projected light towards a specific area. Bar may also include where the projector is axially aligned with the light bar, and the mirror or reflector is configured to redirect the light output towards a target area, thereby providing both illumination and projection capabilities in a single unit. Other embodiments of this aspect include corresponding computer systems, apparatus, and computer programs recorded on one or more computer storage devices, each configured to perform the actions of the methods.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 depicts a perspective view of the projector and light bar assembly as disclosed herein according to one or more embodiments shown and described herein;

FIG. 2 depicts a panned-out perspective view of the projector and light bar assembly as disclosed herein according to one or more embodiments shown and described herein;

FIG. 3 depicts an alternative perspective view of the projector and light bar assembly as disclosed herein according to one or more embodiments shown and described herein;

FIG. 4 depicts an alternative panned-out perspective view of the projector and light bar assembly as disclosed herein according to one or more embodiments shown and described herein;

FIG. 5 depicts an exploded perspective view of the projector and light bar as disclosed herein according to one or more embodiments shown and described herein;

FIG. 6 depicts an exploded perspective view of the projector as disclosed herein according to one or more embodiments shown and described herein;

FIG. 7 depicts an alternative exploded perspective view of the projector as disclosed herein according to one or more embodiments shown and described herein;

FIG. 8 depicts a perspective view of the projector as disclosed herein according to one or more embodiments shown and described herein;

FIG. 9 depicts an exploded perspective view of the projector as disclosed herein according to one or more embodiments shown and described herein;

FIG. 10 depicts an alternative exploded perspective view of the projector as disclosed herein according to one or more embodiments shown and described herein;

FIG. 11 depicts a partially exploded perspective view of the projector and light bar assembly as disclosed herein according to one or more embodiments shown and described herein;

FIG. 12 depicts a perspective exploded view of the lens stack as disclosed herein according to one or more embodiments shown and described herein;

FIG. 13 depicts a side view of the light bar and projector assembly according to one or more embodiments shown and described herein;

FIG. 14 depicts a side view of the light bar and projector assembly according to one or more embodiments shown and described herein;

FIG. 15 depicts a cross-sectional view along 15-15 of FIG. 14 according to one or more embodiments shown and described herein;

FIG. 16 depicts a side view of the light bar and projector assembly according to one or more embodiments shown and described herein;

FIG. 17 depicts a side view of the light bar and projector assembly according to one or more embodiments shown and described herein;

FIG. 18 depicts a side view of the light bar and projector assembly according to one or more embodiments shown and described herein;

FIG. 19 depicts a cross-sectional view of FIG. 18 according to one or more embodiments shown and described herein;

FIG. 20 depicts a side view of the light bar and integrated projector assembly according to one or more embodiments shown and described herein;

FIG. 21 depicts a cross-sectional view of a projector according to one or more embodiments shown and described herein;

FIG. 22 depicts a cross-sectional view of a projector with a set-screw according to one or more embodiments shown and described herein;

FIG. 23 depicts a cross-sectional view of a projector with a set-screw adjustment according to one or more embodiments shown and described herein;

FIG. 24 depicts a cross-sectional view of a projector with a set-screw according to one or more embodiments shown and described herein;

FIG. 25 depicts a cross-sectional view of a projector with a set-screws according to one or more embodiments shown and described herein;

FIG. 26 depicts a cross-sectional view of a projector with a set-screws according to one or more embodiments shown and described herein;

FIG. 27 depicts a cross-sectional view of a projector with locking wedges according to one or more embodiments shown and described herein;

FIG. 28 depicts a cross-sectional view of a projector with locking wedges according to one or more embodiments shown and described herein;

FIG. 29 depicts an exemplary locking wedge according to one or more embodiments shown and described herein;

FIG. 30 depicts a side view of the light bar and projector assembly according with an adjustable attachment according to one or more embodiments shown and described herein;

FIG. 31 depicts a perspective view of the light bar and projector assembly according with an adjustable attachment according to one or more embodiments shown and described herein;

FIG. 32 depicts a perspective view of the light bar and projector assembly according with an adjustable attachment according to one or more embodiments shown and described herein;

FIG. 33 depicts a side view of an attachment member with a tether according to one or more embodiments shown and described herein;

FIG. 34 depicts a perspective view of an attachment member with a tether according to one or more embodiments shown and described herein;

FIG. 35 depicts a perspective view of an attachment member with a tether according to one or more embodiments shown and described herein;

FIG. 36 depicts a side view of an attachment member with a tether according to one or more embodiments shown and described herein;

FIG. 37 depicts a perspective view of an attachment member with a tether according to one or more embodiments shown and described herein;

FIG. 38 depicts a perspective view of an attachment member with a tether according to one or more embodiments shown and described herein;

FIG. 39 depicts a side view of an attachment member with a tether according to one or more embodiments shown and described herein;

FIG. 40 depicts a perspective view of an attachment location of a light in-board of the punch flange and between the pinch flange and centerline of the vehicle according to one or more embodiments shown and described herein;

FIG. 41 depicts a perspective view of the light assembly of FIG. 40 according to one or more embodiments shown and described herein;

FIG. 42 depicts a perspective view of the light assembly of FIG. 40 according to one or more embodiments shown and described herein;

FIG. 43 depicts a perspective view of the light assembly of FIG. 40 according to one or more embodiments shown and described herein; and

FIG. 44 depicts a perspective view of the light assembly of FIG. 40 according to one or more embodiments shown and described herein.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

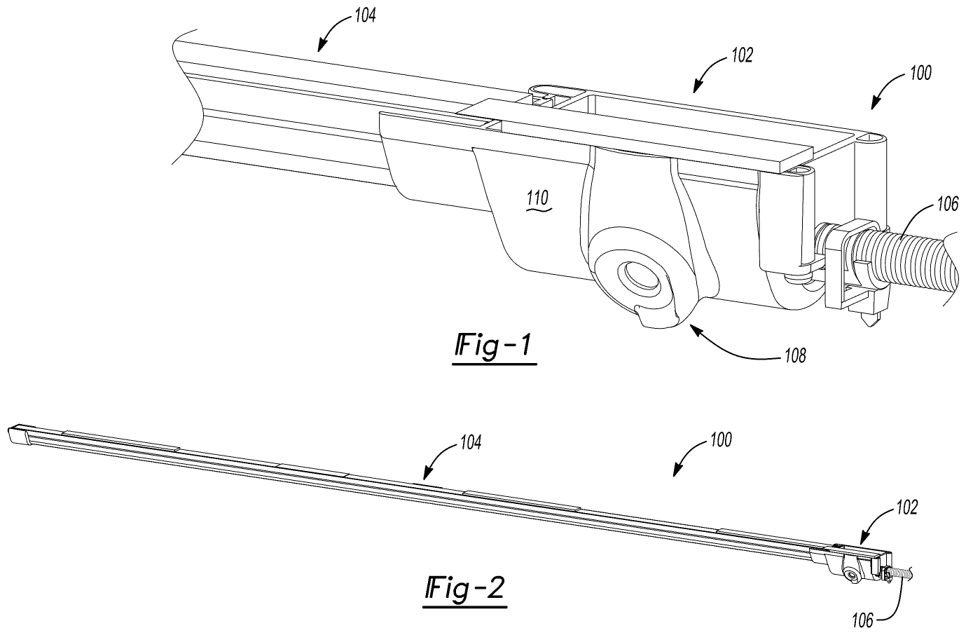

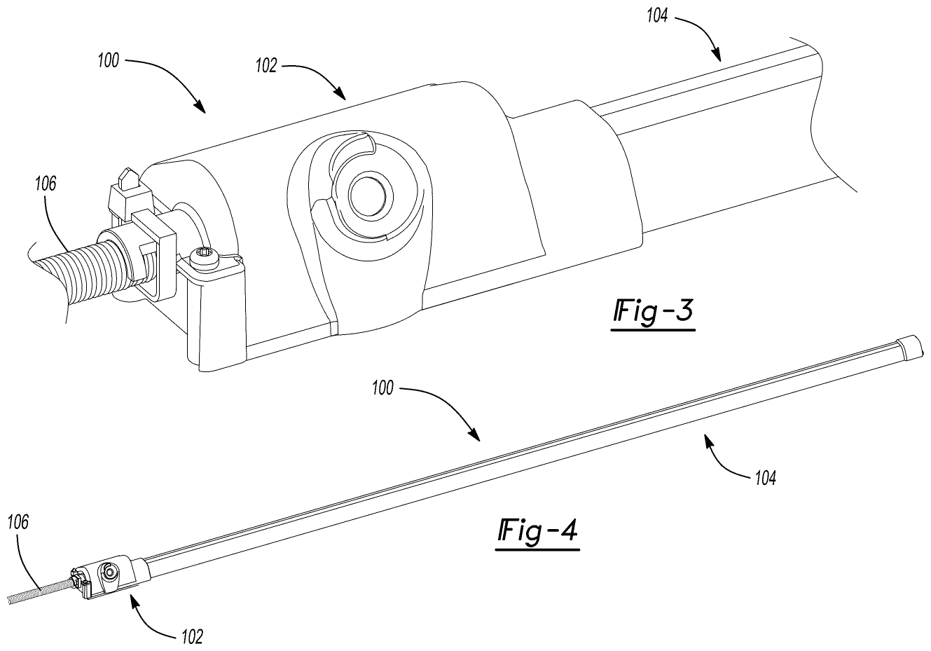

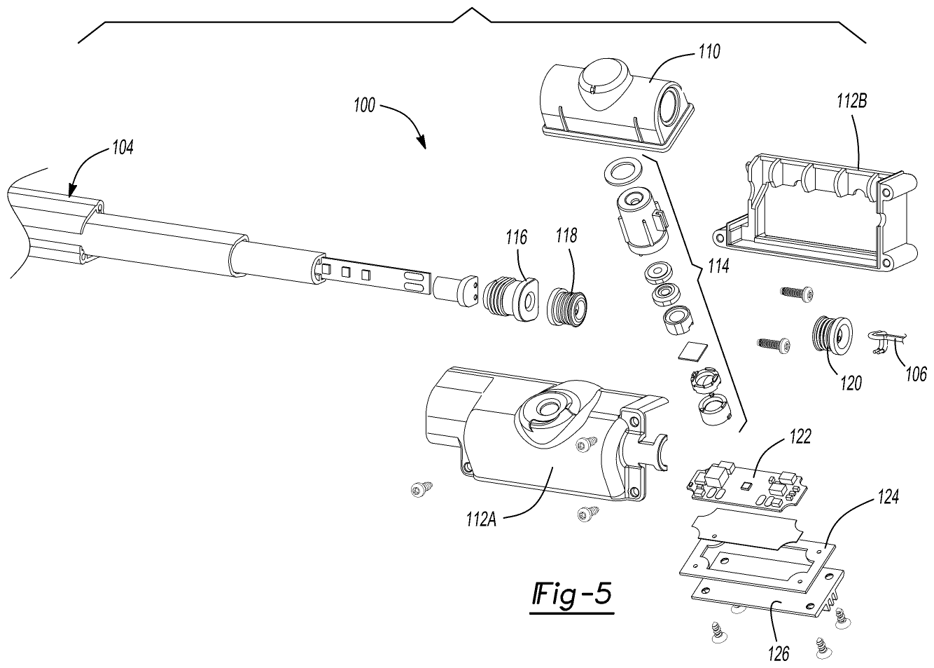

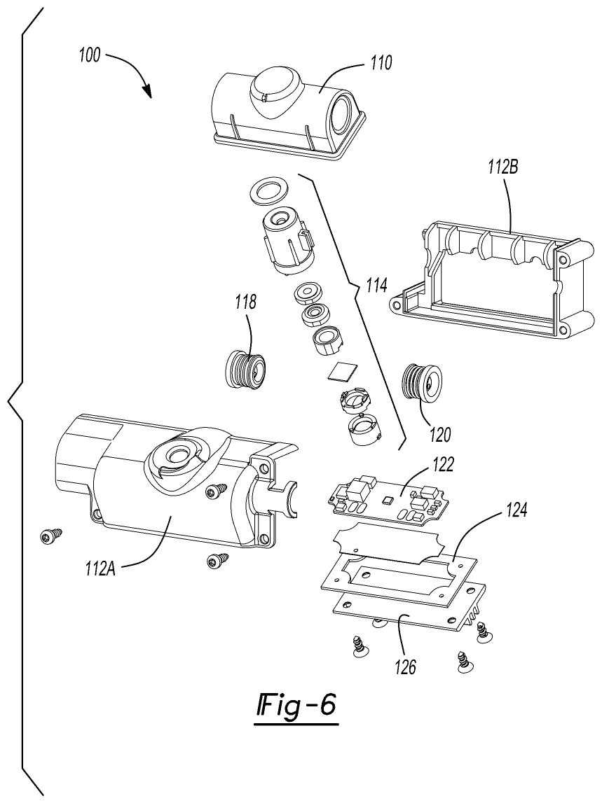

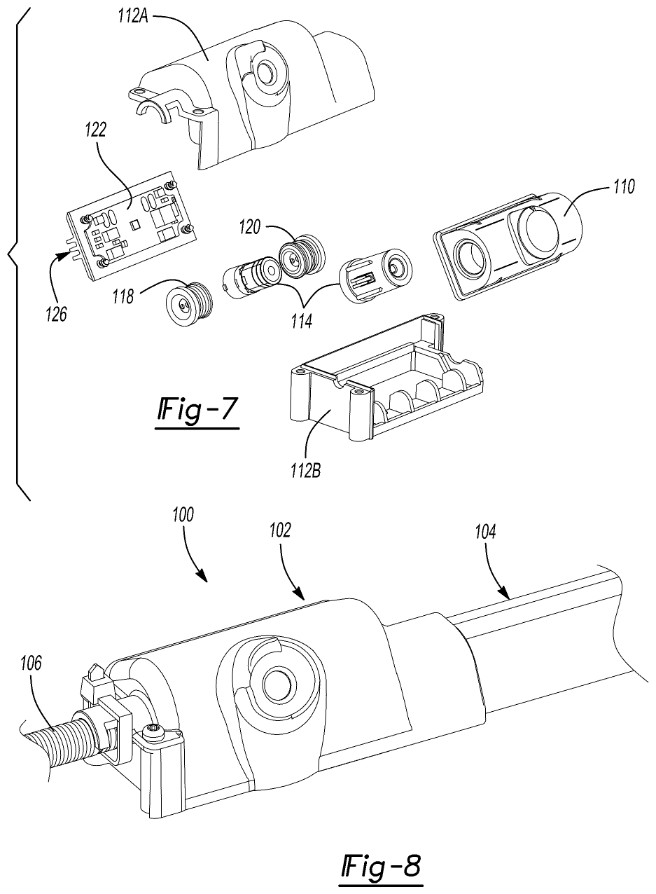

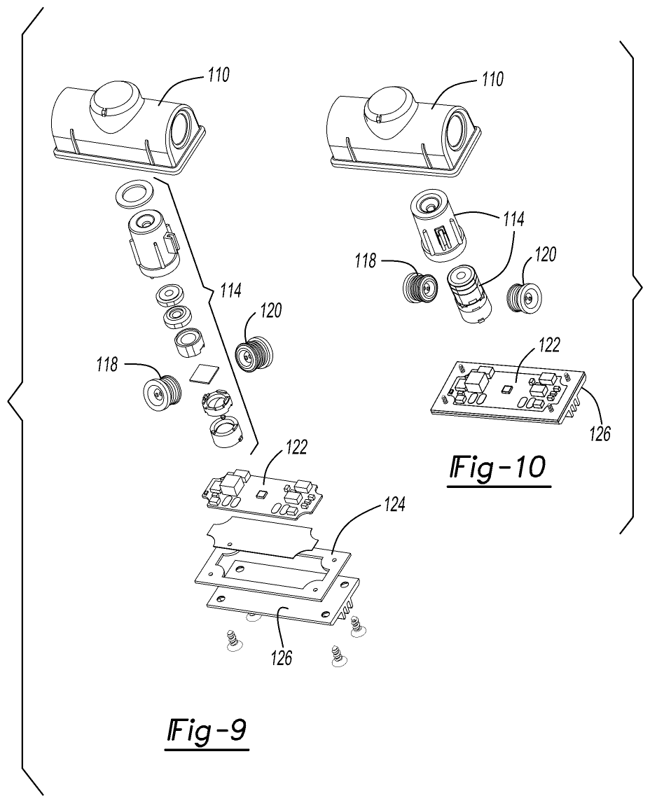

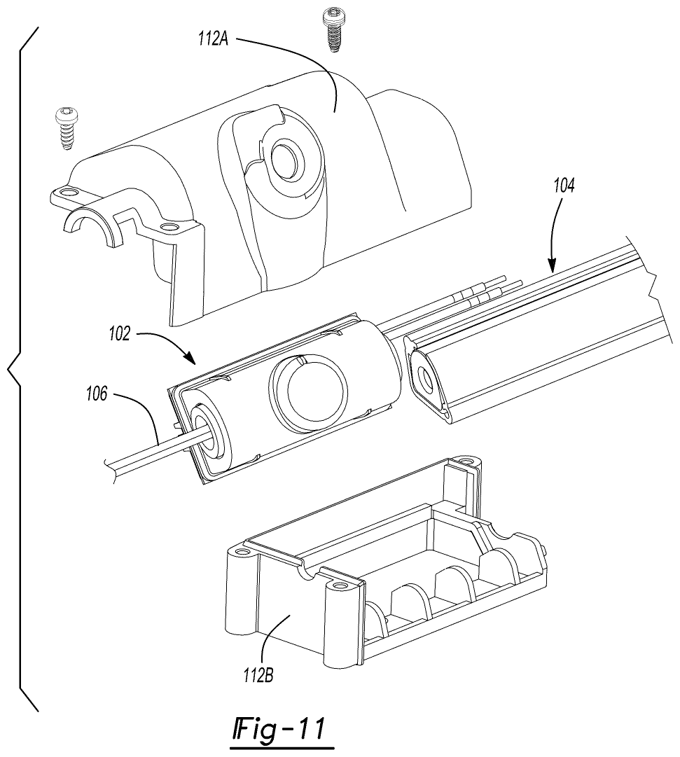

Now referring to FIG. 1, a light assembly 100 includes a projector 102 integrally connected to a light bar 104. The projector 102 and the light bar 104 share power and control wires from a wire harness 106. The projector 102 includes a projector aperture 108 whereby light (oftentimes in a pattern or logo formation) passes therethrough and directs onto a ground surface. The projector 102 includes a light assembly 110 configured to hold the components for projection. In some embodiments, the light assembly 110 is clear allowing light to pass therethrough. The light assembly 110 is sealed so as to protect the projector and lens components. Lens components, also referred to as a lens stack, 114 are sealed within the light assembly 110. The lens stack has a minimized or reduced heights size and include a customizable image slide. The customizable image slide enables customization with preferred logos and/or patterns for projection onto a ground surface. The lens stack 114 includes various components and elements to successfully projection an image, logo, insignia . . . etc. onto a surface from a vehicle. In the present embodiment, the lens stock 114 includes several connected elements including a collimation lens set 200, an image slide 202, a zoom and aberration lens set 204, a lens pack cylinder 206, and a foam gasket 208. In use, each of these elements are stacked together to project the image shown on the image slide 202. The collimation lens set 200 converts light source rays from diverging point to parallel light. The image slide 202 includes a basic image or shape where the keystone and aspect ratio are adjusted. The zoom and aberration lens set 204 controls image magnification and consistency of shape and focus. The lens pack cylinder 206 houses the lens stack, controls depth and orientation of lenses, and eliminates stray lights. The foam gasket 208 protects the lens stack components previously discussed and as shown and helps control depth tolerance.

The light assembly 100 further includes a cover 112A, 112B configured to house and cover the light assembly 110. The cover 112A, 112B is a two-shell piece design. Cover 112A includes an endcap and covers a front portion of the light assembly 110. Cover 112B connects to the cover 112A and covers a rear portion of the light assembly 110. Various screws and grommets 116, 118, 120 are configured to secure the assembly 100 together. The endcaps of covers 112A, 112B retain the light assembly 110 onto the end of the light bar 104 and promotes a continuous linear low-profile format. Potting material (such as silicone or other materials having similar properties) may be used inside of the cover 112A, 112B to further seal from external environmental conditions. The cover 112A, 112B is intended to further protect the light assembly 110 from impact damage.

The assembly 100 further includes a printed circuit board 122, a gasket 124 and an extruded heatsink 126 in a stacked configuration. The printed circuit board 122 (“PCB”) is an LED PCB include the projector circuitry, driver circuitry and includes passthrough circuitry for the light bar 104. The heatsink 126 provides for thermal management of the LEDs and drive circuitry. The heatsink 126 is thermally coupled to the PCB 122 to promote thermal management. In the present embodiment, the passthrough circuitry eliminates additional components and thus reduces weight, number of parts, and/or cost. In the present embodiment, the power source connects directly to the projector and directly to the light bar. Specifically, a single wire connects to the projector via the PCB 122 (solder). From there a single wire from the PCB 122 extends to the light bar. As such, the number of parts are directly minimized by using a direct solder. A first power source wire from the vehicle is soldered directly to a printed circuit board 122 in a projector housing, a second power source wire soldered to the printed circuit board and extending to the light bar, wherein reducing wires and providing for a pass-through power configuration reduces parts and thus cost to the vehicle.

The assembly 100 is configured for use on a vehicle wherein the vehicle includes a vehicle body, a front door, a rear door and a rocker panel (or other trim). The assembly 100 is configured to mount to an outer perimeter to a vehicle (likely to attached to the rocker panel or connecting structure) so as to project light outwards of the outer perimeter onto the ground surface on which the vehicle rests (see photos of Appendix A).

The assembly 100 is designed and configured for quick and easy installation to one or both sides of the vehicle as desired. The assembly 100 can be sold as an aftermarket accessory that is subsequently installed to the vehicle according to preference. In other embodiment, the projector 102 of the assembly 100 is sold an auxiliary product to the light bar 104. In these embodiment, the projector may be installed after the light bar 104 is already installed, as an aftermarket product or otherwise.

The assembly 100 is advantageous in that the projector 102 is configured to use the same power source of the light bar 104. In some embodiments, if a light bar is already installed to provide a “welcome light”, a power supply is already provided in the general area of the vehicle making installation easier. In other embodiments (at factory installation), the number of wires may be reduced when using the same power supply to both the projector 102 and the light bar 104 in the assembly 100. Reducing wires and providing for a pass-through power configuration reduces parts and thus cost to the vehicle.

### Light Bar and Projector Alternative Connection Embodiments

A light assembly having a projector integrally connected to a light bar. The projector and the light bar share power and control wires from a wire harness. The projector includes a projector aperture whereby light (oftentimes in a pattern or logo formation) passes therethrough and directs onto a ground surface. The projector includes a light assembly configured to hold the components for projection.

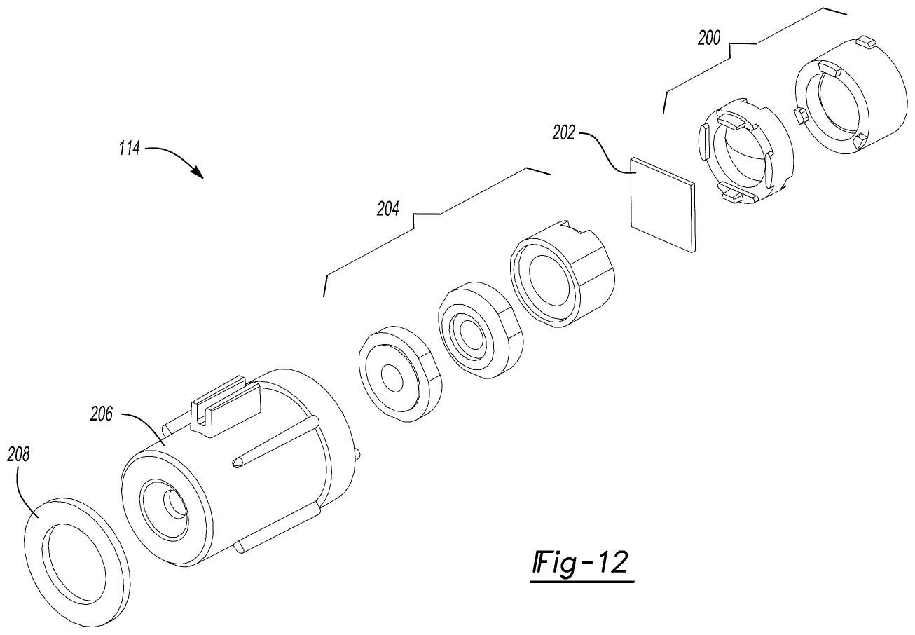

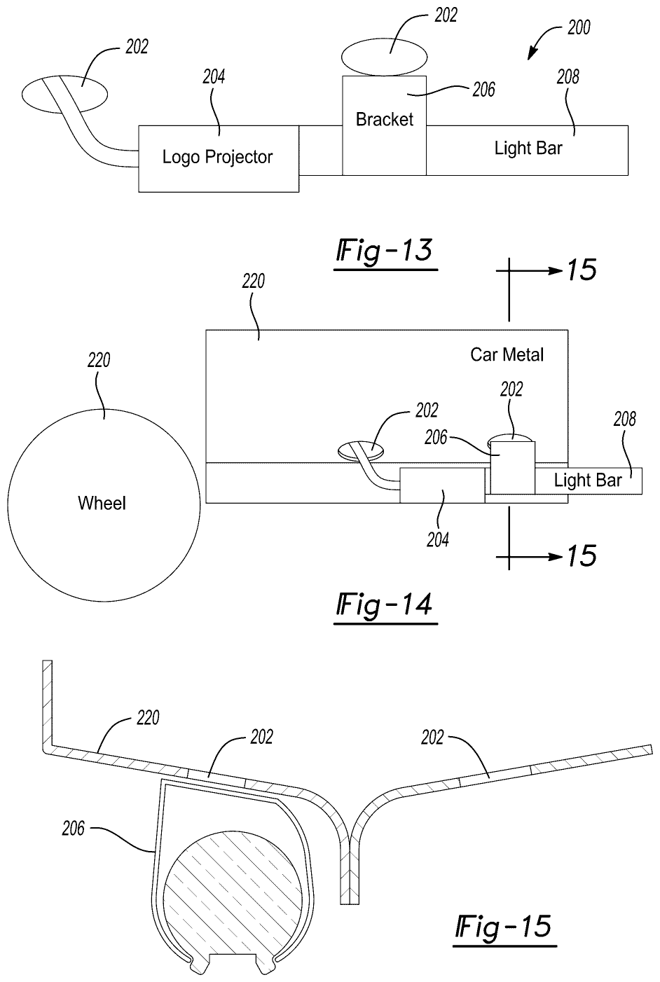

FIGS. 13-20 depict various embodiments of connecting a light bar and/or light bar and projector combination together and/or to the body of the vehicle.

Specifically, FIGS. 13-15 illustrates one embodiment of the light bar assembly 200 whereby the vehicle includes vehicle holes 202. The assembly includes a projector 204 connected to a light bar 208 by means of a bracket disposed between, and physically separating the projector 204 and the light bar 208 from each other. The bracket 206 connects to the vehicle holes. It is best to have the wires enter the vehicle holes 202 which is the front most hole, closer to the wheel 220, in the car underbody structure. The vehicle holes 202 are disposed in the car metal 220. These holes are meant as drain holes for the car body during processing of e-coating. Once the vehicle is coated and drained, they plug the holes and we can remove the plug and add a bracket.

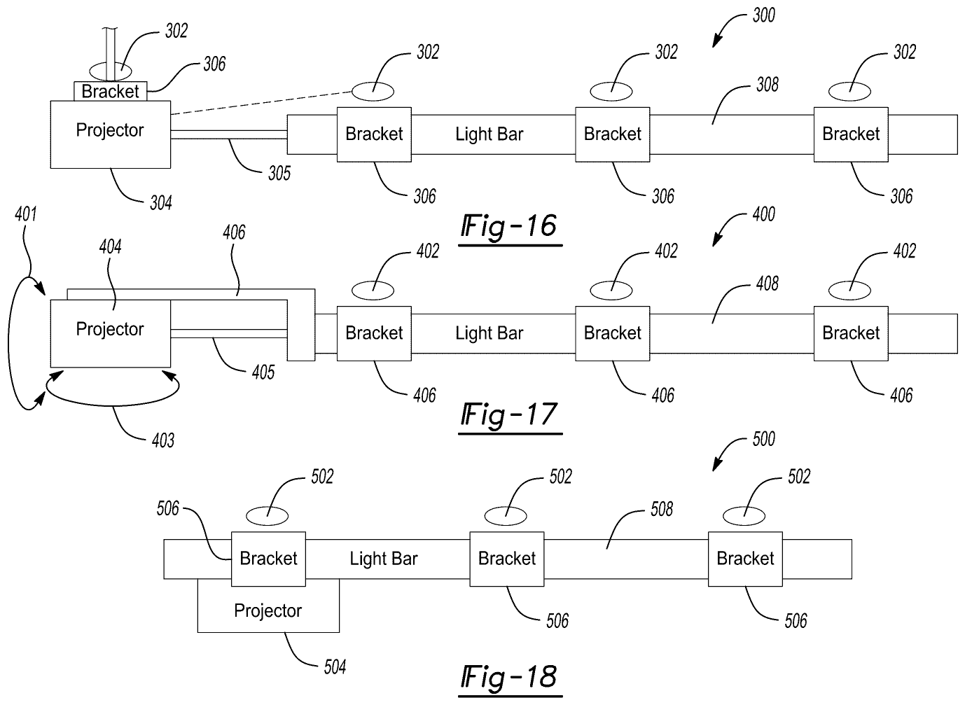

FIG. 16 depicts an alternative arrangement for a light bar and projector assembly 300. The holes 302 allow the brackets 306 to connect thereto. The brackets 306 hold the light bar 308. A wire or wire harness 305 connects to the projector 304 and the projector 304 is not directly connected to the light bar 308.

FIG. 17 depicts an alternative arrangement for a light bar and projector assembly 400. The holes 402 allow the brackets 406 to connect thereto. The brackets 406 hold the light bar 408. A wire or wire harness 405 connects to the projector 404 and the projector 404 is not directly connected to the light bar 408. In this embodiment, one of the brackets 406 includes an arm and extends away from the light bar to separately hold the projector 404 so it is not directly connected to and/or touching the light bar 408.

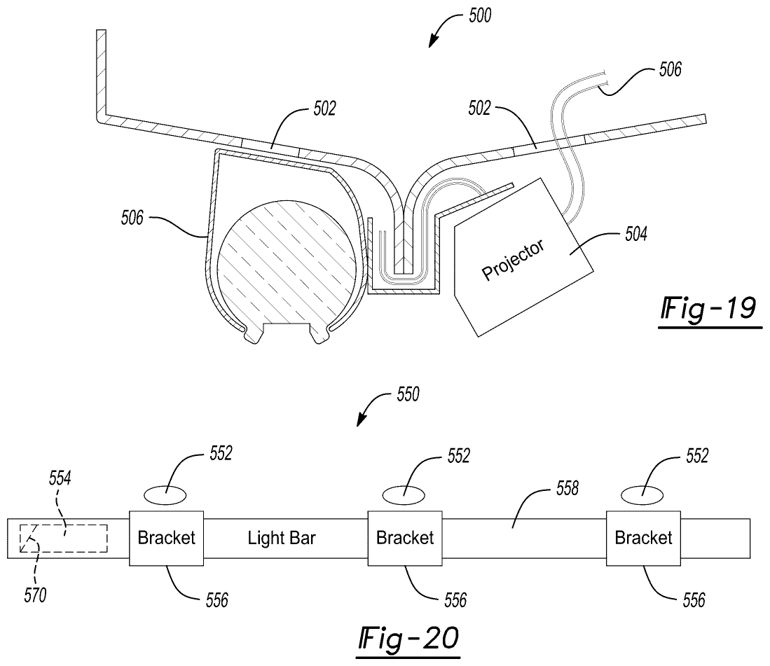

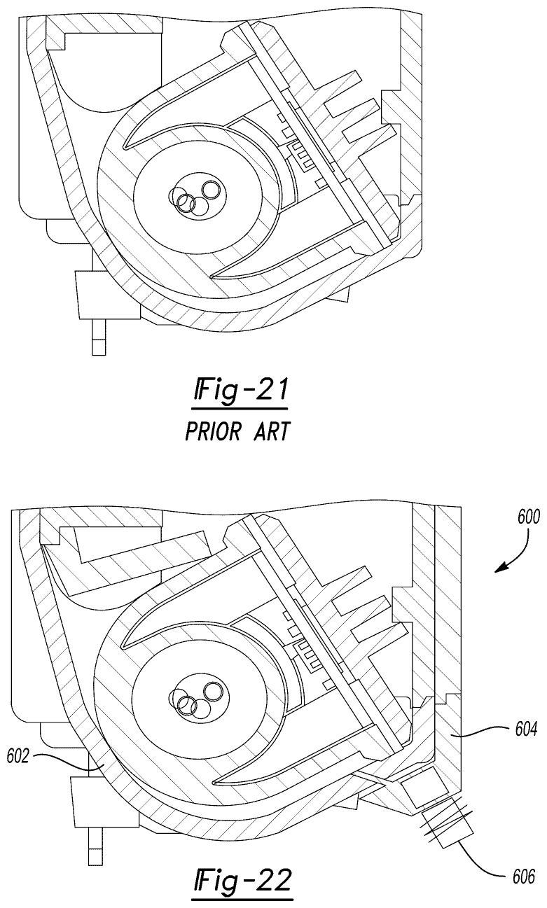

FIGS. 18-19 depicts an alternative arrangement for a light bar and projector assembly 500. The holes 502 allow the brackets 506 to connect thereto. The brackets 506 hold the light bar 508. A wire or wire harness (not shown) connects to the projector 504 and the projector 504 is directly connected to one of the brackets 506 so as to not directly connect the light bar 508 to the projector 504. Instead, the bracket 506 holding the light bar 508 is positioned on an opposite side of the pinch flange having the holes 502.

FIG. 20 depicts a side view of the light bar and integrated projector assembly according to one or more embodiments shown and described herein. FIG. 20 depicts an alternative arrangement for a light bar and projector assembly 550. The holes 552 allow the brackets 556 to connect thereto. The brackets 506 hold the light bar 558. A wire or wire harness (not shown) connects to the projector 504 and the projector 554 is integrated directly within the light bar 558. In this embodiment, the projector 554 includes at least one mirror 570 so as to direct light to the desired area (e.g. the ground below a vehicle. The projector 554 is fully integrated within the light bar. The shape of the projector head is axially pointing into or down the light bar 558 but use a reflector or mirror 570 to make the image directed towards the ground. The reflector or mirror 570 in this embodiment is depicted at generally a 45 degree angle, although any suitable angle may be utilized. The described technology focuses on an innovative light bar and integrated projector assembly, which combines lighting and projection capabilities into a single, streamlined unit. This assembly is designed to enhance the functionality of traditional light bars by incorporating a projector directly within the light bar structure. The projector is strategically positioned to direct light towards a specific area, such as the ground below a vehicle, using an internal mirror or reflector. This integration not only saves space but also provides a dual functionality that can be particularly useful in automotive applications, where both illumination and projection are required.

In this embodiment, the light bar is supported by brackets, which are connected through pre-formed holes, ensuring a sturdy and secure attachment. The projector itself is seamlessly integrated within the light bar, eliminating the need for additional external components. This integration is facilitated by a wire or wire harness that connects to the projector, ensuring that it receives the necessary power and signals to operate effectively. The design of the projector head is such that it aligns axially with the light bar, yet it employs a mirror to redirect the projected light or image to the desired area.

A key feature of this assembly is the use of a mirror or reflector positioned at an angle, typically around 45 degrees, to direct the light output from the projector. This angled positioning allows for flexibility in directing the light to various target areas without altering the orientation of the light bar itself. The angle of the mirror can be adjusted to suit different applications, making this technology versatile and adaptable to a range of lighting and projection needs. By integrating these components, the assembly reduces the complexity and bulk associated with separate lighting and projection systems.

Overall, this light bar and integrated projector assembly represents a significant advancement in lighting technology, offering a compact and efficient solution for applications that require both illumination and projection. The integration of the projector within the light bar not only enhances functionality but also contributes to a more aesthetically pleasing and streamlined design, and is also lower profile.

### Tunable Image Angle

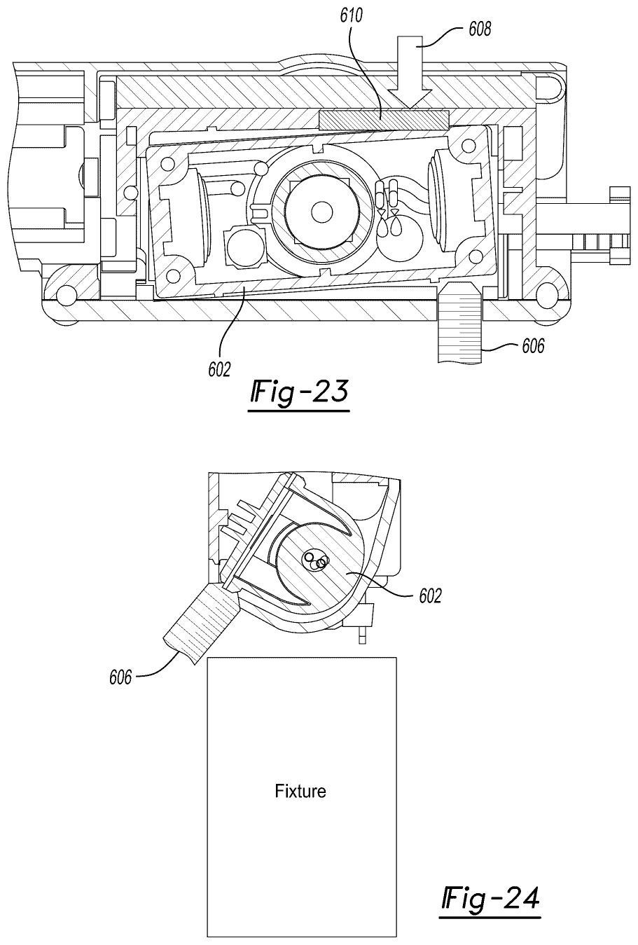

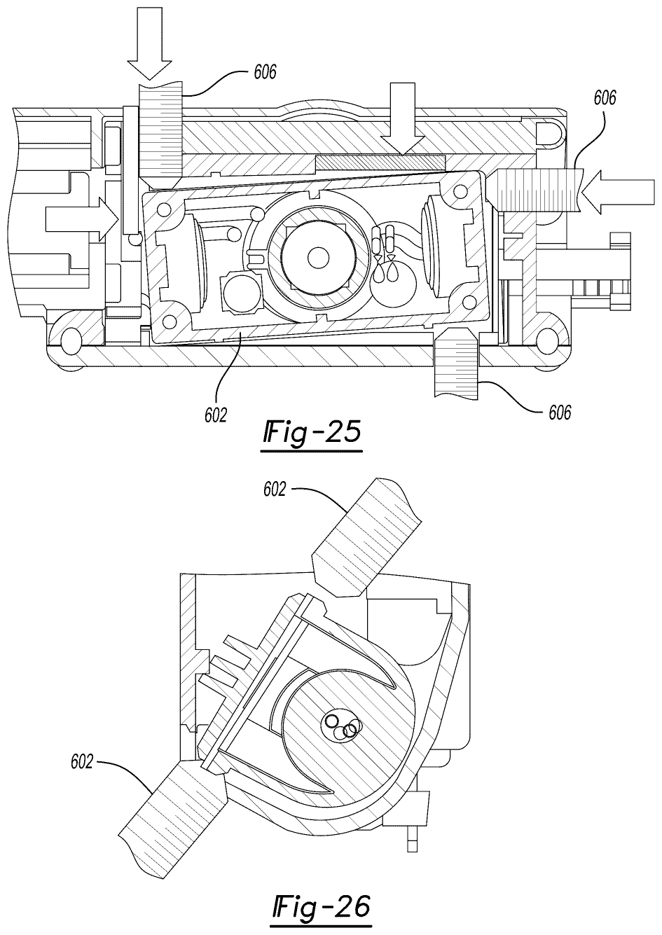

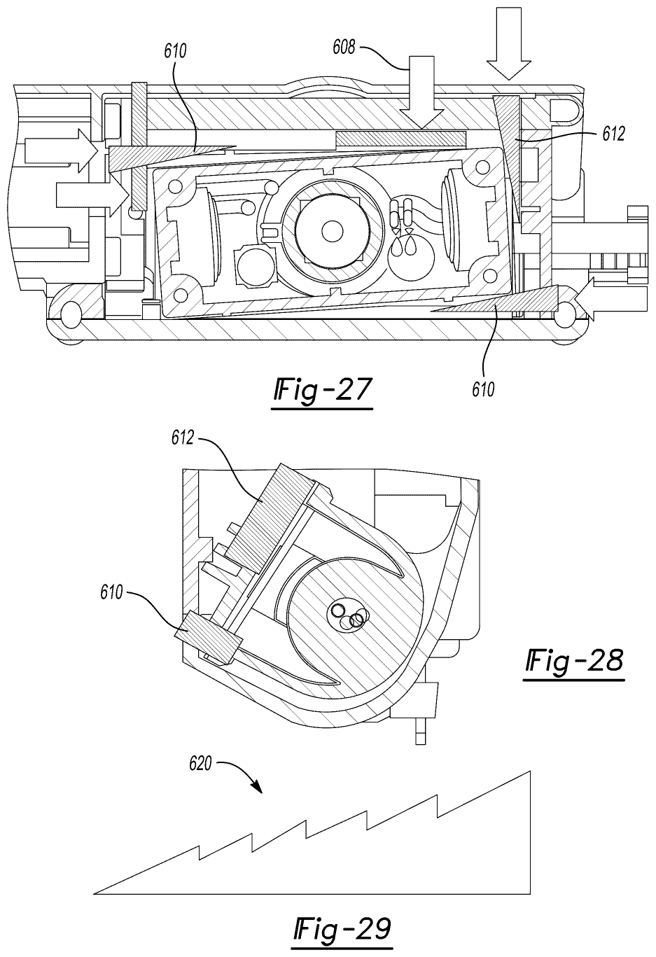

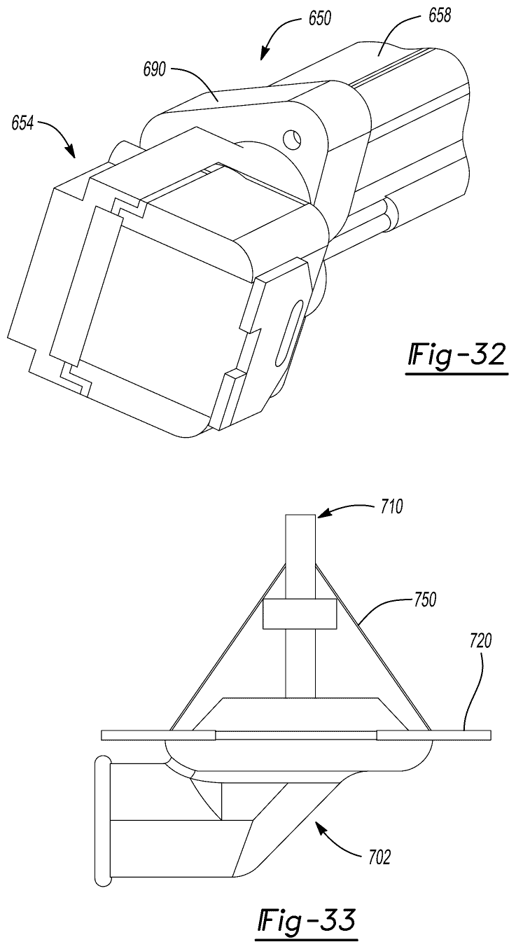

FIGS. 22-32 depict various embodiments for adjusting the angle and/or position of the projector. In FIG. 22, the assembly 600 includes adjustment by means of a setscrew 606 held within a bracket 600. FIGS. 23-26 illustrates a spring finger 608, 610 along with a setscrew 606 to adjust the housing 602. FIGS. 27-30 depict various embodiments whereby locking wedges 610, 612, 620 are used to adjust the housing.

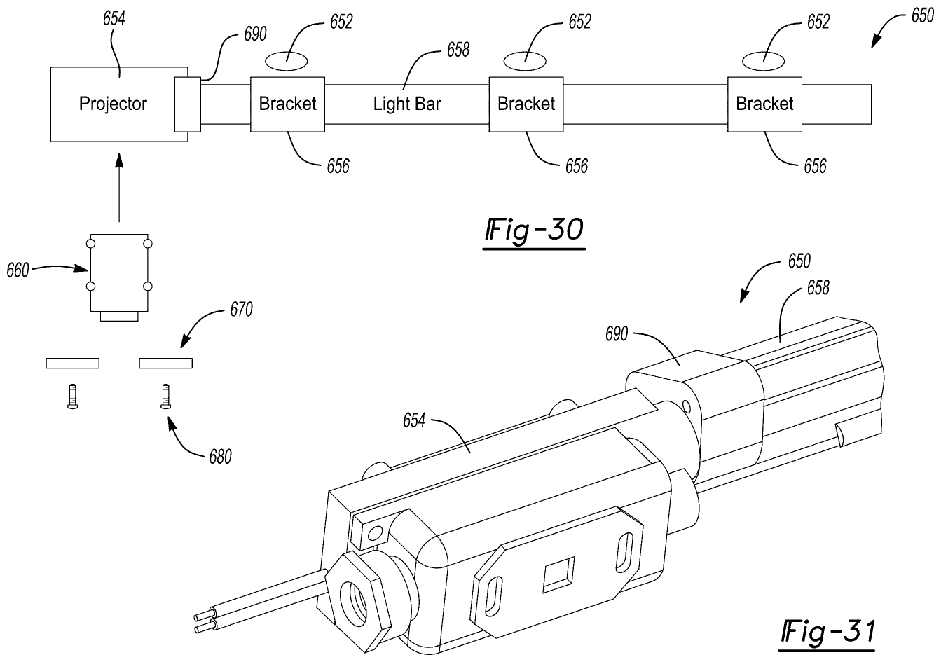

FIGS. 30-32 depict a more universal component for adjustment. The benefit of this design is that the inventory management is improved. All products can be configured to be made from 3LH and 3 RH part base numbers by adding a lens pack. The angle adjustment plate allows for fine tuning. A heat sink can be positioned on the housing of the projector. The housing may be 2 pieces, sealed with an o-ring or similar. The adjustable attachment is a bracket, crimp or clamp. The face plate 670 can be threaded in or installed with other fasteners. The adjustable face plate(s) 670 may also function as a heat sink. If made of metal, it protects the projector and other components from rock strikes. A lens stack 660 of the projector can be installed so that the correct model or image can set in place towards the end of manufacturing, or even post production, or in the field. The technology described revolves around a versatile lens stack system, identified as lens stack 660, designed for use in projectors. This system is engineered to enhance the flexibility and functionality of projectors by allowing for the installation or replacement of lenses at various stages of the product lifecycle. The lens stack 660 can be integrated during the final stages of manufacturing, enabling manufacturers to tailor the optical configuration to specific requirements or customer preferences. This adaptability ensures that the projector can be customized to deliver optimal image quality and performance for different applications or environments.

One of the key advantages of this lens stack technology is its ability to facilitate post-production customization. After the projector has left the manufacturing facility, the lens stack 660 can be adjusted or replaced to meet evolving consumer needs or to incorporate advancements in lens technology. This feature is particularly beneficial in rapidly changing markets where consumer demands and technological capabilities are constantly evolving. By allowing for post-production modifications, manufacturers can extend the lifespan of their products and reduce the need for complete overhauls, thereby offering a more sustainable and cost-effective solution.

Furthermore, the lens stack 660 provides significant benefits for field applications. In scenarios where projectors are deployed in diverse settings or where different projection requirements arise, the lens stack can be easily swapped or adjusted on-site. This capability is invaluable for professionals who rely on projectors for presentations, events, or installations, as it allows them to adapt the equipment to various projection surfaces, distances, and lighting conditions without the need for extensive downtime or specialized tools. The ease of field customization enhances the projector's versatility, making it a preferred choice for dynamic environments.

Overall, the lens stack 660 represents a significant innovation in projector technology, offering a robust solution for both manufacturers and end-users. By enabling customization at multiple stages of the product lifecycle, it addresses the growing demand for flexible and adaptable projection systems. This technology not only supports the creation of tailored visual experiences but also aligns with broader trends towards modularity and sustainability in consumer electronics. As such, the lens stack 660 is poised to become a critical component in the design and deployment of next-generation projectors.

The technology described is a tunable image angle light projector assembly, designed to project images or patterns onto a ground surface with adjustable orientation. At the core of this assembly is a projector that is configured to connect to a light bar via an attachment mechanism, such as a bracket, crimp, or clamp. This connection allows the projector to rotate around an axis that is parallel to its longitudinal axis, providing the flexibility to adjust the direction in which the image is projected. The projector includes a projector aperture through which light is emitted, enabling the projection onto the desired surface.

A key component of this technology is the light housing, which is designed to be rotatably coupled to the projector. This housing can rotate around an axis perpendicular to the longitudinal axis of the projector, allowing for further adjustment of the projection angle. To maintain the desired orientation, the light housing can be locked into position using at least one locking mechanism, which may include options such as a set screw, locking wedge (with or without teeth), angle wedge, flat wedge, or a spring. The light housing is also designed to be clear, ensuring that light can pass through without obstruction, and it is sealed to protect the internal components from environmental factors.

The light projector assembly is designed to be integrated with a light bar, which can share power and control signals via a wire harness. This integration ensures that the projector and light bar operate in a synchronized manner, enhancing the efficiency and functionality of the system. The projector's ability to connect with the light bar through shared wiring simplifies installation and reduces the complexity of the overall setup, making it a practical solution for various applications.

Furthermore, the lens components within the light housing are crucial for the quality and customization of the projected image. These components may include a collimation lens set, a zoom and aberration lens set, and an image slide that can feature a preferred logo or pattern. This configuration allows users to tailor the projected image to specific needs, whether for branding, decorative, or informational purposes. The combination of adjustable angles and customizable image options makes this tunable image angle light projector assembly versatile and suitable for a wide range of applications, from commercial advertising to architectural lighting design.

A light projector assembly 650 configured to connect to a light bar 658, may include: a projector 654 having a longitudinal axis, where the projector is configured to rotatably couple to the light bar 658 via an attachment item 690; the projector being configured to rotate around an axis parallel to its longitudinal axis; the projector 654 having a projector aperture where light passes therethrough and directs onto a ground surface; the projector being configured to receive a light housing 602, where the light housing is rotatably coupled to the projector; the light housing being configured to rotate around an axis perpendicular to the longitudinal axis of the projector, where the light housing may be locked in a desired position relative to the projector via at least one locking mechanism; the light housing may include lens components, where the light housing is sealed so as to protect the projector and the lens components; and the light housing being clear allowing light to pass therethrough.

The light projector assembly further may include a light bar.

The light projector assembly where the projector and the light bar share power and control wires from a wire harness.

The light projector assembly, where the at least one locking mechanism may be a set screw, a locking wedge, a locking wedge with teeth, an angle wedge, a flat wedge, and/or a spring.

The light projector assembly of any one of examples above, having two locking mechanisms.

The light projector assembly of any one of the above examples having three locking mechanisms.

The light projector assembly of any one of the above examples where the attachment item is a bracket, a crimp, and/or a clamp.

The light projector assembly of any one of the above examples where the lens components may include a collimation lens set, a zoom and aberration lens set, and/or an image slide with a preferred logo and/or pattern for projection onto a ground surface.

### Body Sheet Metal Mount Adjacent to Pinch Flange

The present disclosure is directed to an improved connection means for a light bar to a vehicle, specifically an improved clamp (and other retention features) for connecting a light bar to the body sheet metal often adjacent to the pinch flange on the bottom of a vehicle. Alternatively, the mounting may occur to the sheet metal holes or generally to the vehicle undercarriage, but regardless adjacent to said pinch flange. In some embodiments, the improved clamp is configured to deform the metal to provide secure retention of the light item. This method includes providing a seal around the deforming tool such that damage to paint will not cause corrosion to the vehicle. In order to deform the metal high force brackets are needed, several designs shown herein. Further, a tether may be used to provide an additional (or alternative) retention means of the light bar to the vehicle. The tether may be connected at each bracket. The tether may be connected at any drain hole. The tether may connected at the wire to vehicle entrance.

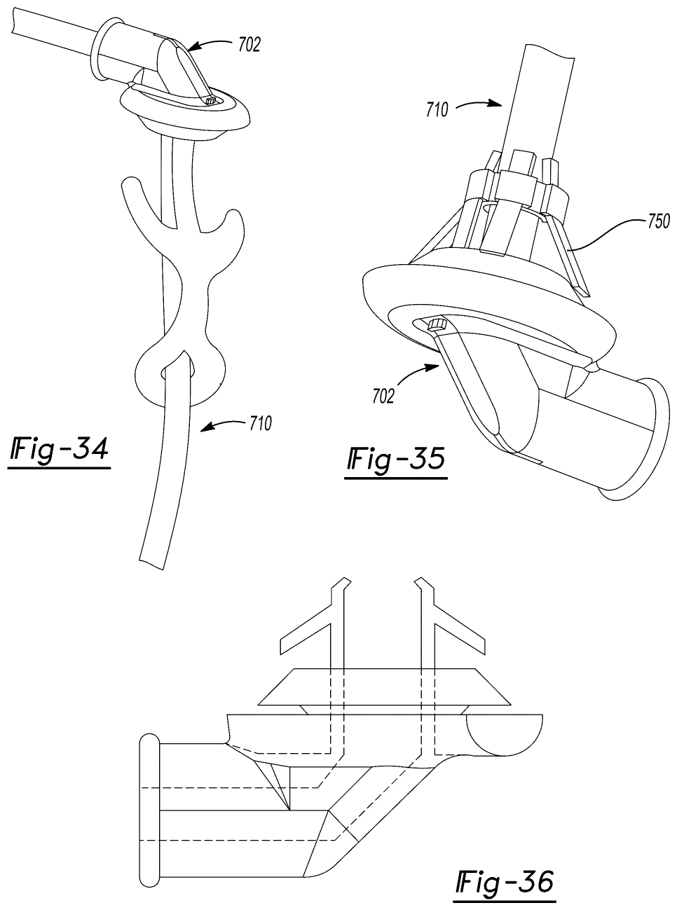

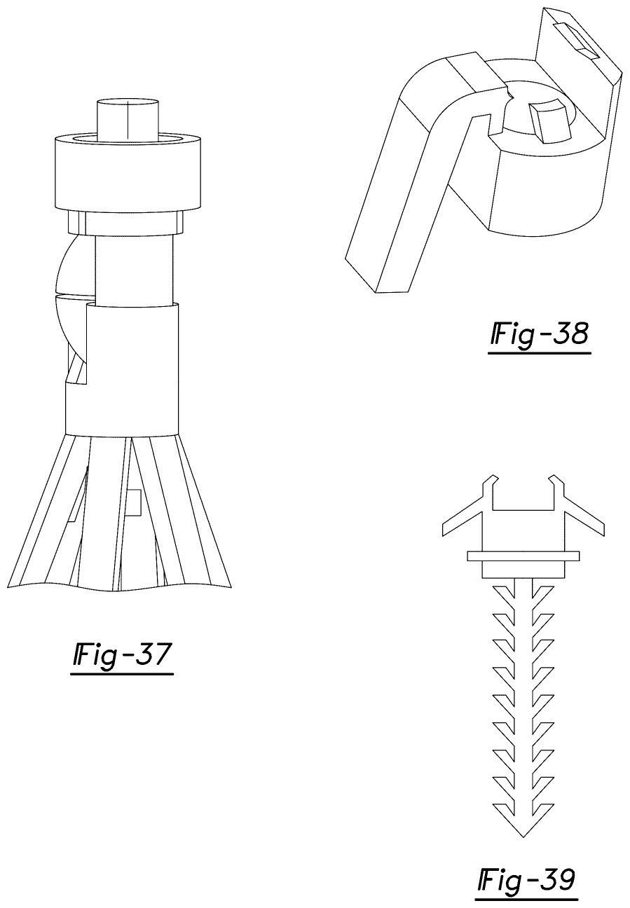

FIGS. 33-39 illustrate various embodiments of tethers used as an added measure to secure the light bar 102 to the vehicle. FIG. 33 depicts a grommet and tether assembly 700 including a grommet 702 connected to a tether 704 which connects to a bracket. The bracket connects to the body sheet metal mount. The tether acts as an added security measure in the event that the light bar becomes disconnected from the vehicle. In the embodiment as shown in FIG. 33, the tether 750 acts as extra security by connecting the bracket directly to the vehicle.

In some embodiments, such as illustrated in FIGS. 33-36, a tether 750 connects to an existing cord 710 of a light bar. The tether 750 connects to the grommet 702 through the sheet metal 720 of the vehicle. The tether 750 connects directly to the cord 710 of the light bar thereby securing the entire LED light bar 102 to the vehicle. Various other embodiments of tether configurations are illustrated in the following FIGS. 38-39.

A connection means for a light bar to a vehicle, specifically an improved clamp (and other retention features) for connecting a light bar to the body sheet metal mount on the bottom of a vehicle. In some embodiment, the improved clamp is configured to deform the metal of the body sheet metal mount to provide secure retention of the light item. This method includes providing a seal around the deforming tool such that damage to paint will not cause corrosion to the vehicle. In order to deform the metal of the body sheet metal mount high force brackets are needed, several designs shown herein. Further, a tether may be used to provide an additional (or alternative) retention means of the light bar to the vehicle. The tether may be connected at each bracket. The tether may be connected at any drain hole. The tether may connected at the wire to vehicle entrance.

An improved connection means for a light bar to a vehicle, specifically an improved clamp (and other retention features) for connecting a light bar to the body sheet metal mount on the bottom of a vehicle. In some embodiment, the improved clamp is configured to deform the metal of the body sheet metal mount to provide secure retention of the light item. This method includes providing a seal around the deforming tool such that damage to paint will not cause corrosion to the vehicle. In order to deform the metal of the body sheet metal mount high force brackets are needed, several designs shown herein. Further, a tether may be used to provide an additional (or alternative) retention means of the light bar to the vehicle. The tether may be connected at each bracket. The tether may be connected at any drain hole. The tether may connected at the wire to vehicle entrance.

Connection Assembly Overview. The present invention relates to a connection assembly, designated generally as 9A, which comprises several key components for securing a light bar wire to a vehicle's body sheet metal mount. The assembly includes:

Grommet 702: The grommet is configured to be partially received within an opening of a body sheet metal mount of a vehicle.

Light Bar Wire: This component is designed to be received within the grommet.

3. Tether 704: The tether is configured to couple the light bar wire to the body sheet metal mount of the vehicle.

Grommet Configuration. The grommet includes a first portion that is partially received within the opening of the body sheet metal mount, having a first longitudinal axis substantially perpendicular to the body sheet metal mount. A second portion connected to the first portion, with a second longitudinal axis oriented at approximately 45 degrees relative to the body sheet metal mount. A third portion connected to the second portion, having a third longitudinal axis substantially parallel to the body sheet metal mount.

Light Bar Wire Orientation. The light bar wire is oriented within the grommet such that: A first portion of the light bar wire extends along the first longitudinal axis of the grommet. A second portion extends along the second longitudinal axis. A third portion extends along the third longitudinal axis.

Tether Configuration. The tether includes a circular portion positioned around the first portion of the light bar wire, configured to connect to it. At least one arm configured to connect the circular portion and the first portion of the light bar wire to the body sheet metal mount.

Light Bar Wire Extension. The first portion of the light bar wire includes at least one extension arm extending away from the first longitudinal axis of the grommet.

Interference Portion of the Tether. In this configuration, the tether includes an interference portion positioned around the first portion of the light bar wire, with at least one opening around its circumference. At least one arm configured to connect the interference portion to the body sheet metal mount.

The extension arm of the light bar wire extends through the opening in the interference portion, thereby preventing movement of the interference portion relative to the body sheet metal mount along the first longitudinal axis of the grommet.

Connector Portion of the Tether. The tether further includes a connector portion positioned around the first portion of the light bar wire, configured to connect to it via at least one intermediate arm. At least one arm configured to connect the connector portion, the first portion of the light bar wire, and the body sheet metal mount.

Sheath Portion of the Tether. The tether also includes a sheath portion configured to be received in the grommet, positioned around the first, second, and third portions of the light bar wire, and configured to connect to these portions via at least one intermediate arm. At least one arm configured to connect the sheath portion to the body sheet metal mount.

The described connection assembly provides a robust and versatile solution for securing light bar wires to vehicle metal, accommodating various orientations and configurations to meet specific installation requirements.

### Pinch Flange Adjacent Low-Profile Light and Positioning (Centerline)

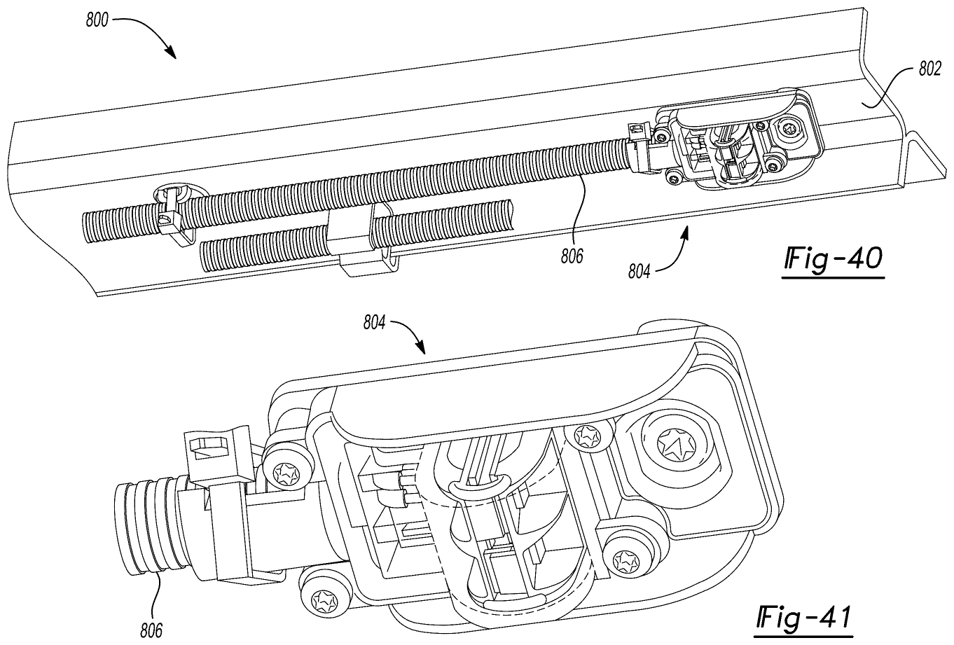

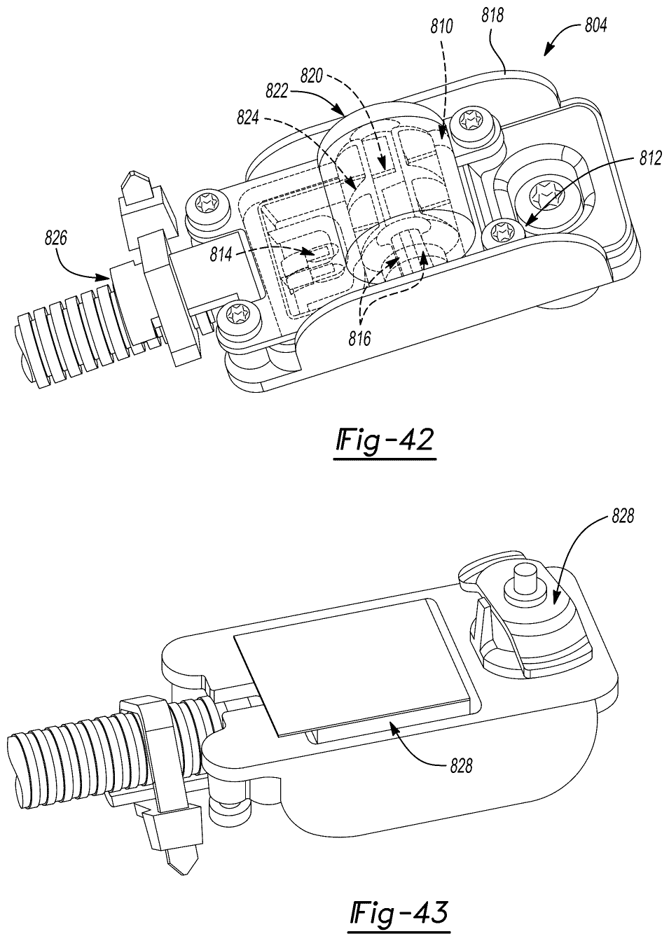

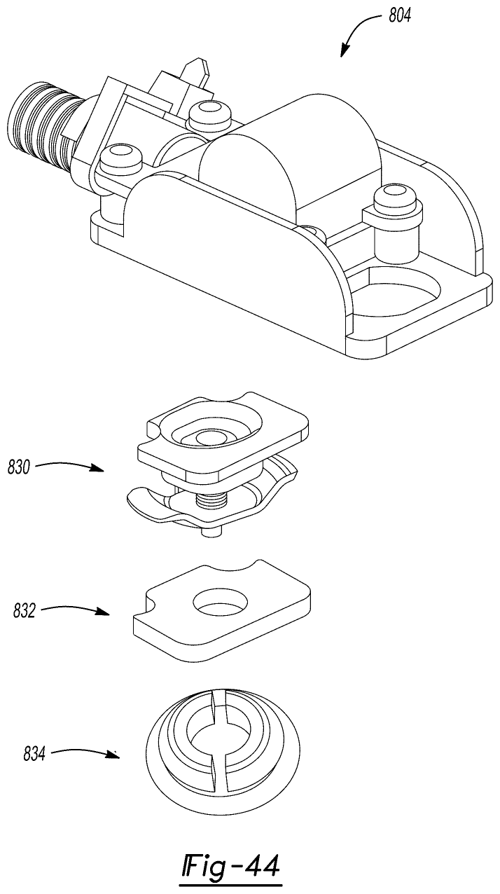

Low-Profile Light Assembly is shown in FIGS. 40-44. The present specification relates to a low-profile light assembly, designated generally as 800, which is particularly suitable for vehicular applications. The assembly comprises a pinch flange 802 that extends linearly between the fore and aft sections of a vehicle. A light housing 804 is operatively coupled to the vehicle undercarriage 802 directly adjacent to the pinch flange, wherein said light housing is configured to direct illumination in both fore 814 and aft 816 directions. Notably, the first light housing 804 is strategically positioned between the pinch flange 802 and the vehicle's centerline (or inboard), thereby rendering it concealed from the view of an external observer. The technology described involves a lighting system integrated into a vehicle's design, specifically focusing on the strategic placement of a light housing component. This light housing is identified as the first light housing and is a critical element of the vehicle's lighting architecture. By positioning this light housing between the pinch flange and the vehicle's centerline, the design ensures that the light is discreetly integrated into the vehicle's structure. This placement not only enhances the aesthetic appeal of the vehicle by maintaining a sleek and uninterrupted exterior profile but also serves functional purposes, such as reducing potential damage from external elements and improving aerodynamic performance.

The strategic concealment of the light housing from an external observer is a key aspect of this technology. By embedding the light housing within the vehicle's bodywork, the design minimizes visual clutter and potential distractions for onlookers, thereby contributing to a streamlined and modern appearance. This concealment is particularly beneficial for maintaining the vehicle's design integrity, as it allows for the incorporation of essential lighting components without compromising the vehicle's overall aesthetic. Additionally, this hidden placement can enhance security by protecting the lighting elements from tampering or vandalism.

From a functional standpoint, the positioning of the light housing between the pinch flange and the vehicle's centerline offers several advantages. It allows for optimal light distribution across the vehicle's exterior, enhancing visibility and safety for both the driver and other road users. The placement is also likely to contribute to improved energy efficiency, as the light can be directed precisely where needed, reducing unnecessary light spillage and energy consumption. Furthermore, the central positioning of the light housing can facilitate easier maintenance and replacement, as it is integrated into a more accessible part of the vehicle's structure.

The design considerations involved in this technology reflect a balance between aesthetic, functional, and practical requirements. By integrating the light housing in a concealed yet effective manner, the vehicle's designers have created a solution that enhances both the visual appeal and operational efficiency of the vehicle. This approach demonstrates an innovative use of space and materials, showcasing how modern vehicle design can incorporate advanced technologies while maintaining a focus on user experience and environmental considerations. Overall, the strategic positioning of the light housing represents a forward-thinking approach to vehicle design, emphasizing the importance of integrating technology seamlessly into everyday products.

Alternatively, the assembly 800 may to mounted at the outer side (or outboard) of the pinch flange, although mounted to the metal or the vehicle undercarriage. This embodiment is advantageous in that it enhances light from the projector to project in the correct direction. In other words, the pinch flange can block and/or reflect light away from the pinch flange and/or the vehicle undercarriage and down towards the ground or other desired angle. The described technology pertains to an innovative assembly designed to optimize the projection of light from a vehicle, specifically focusing on the strategic placement of a projector in relation to the vehicle's structural components. In this configuration, the assembly is mounted on the outer side, or outboard, of the pinch flange. The pinch flange is a critical structural element of the vehicle, often found along the edges where panels are joined. By positioning the assembly outboard, the technology ensures that the light emitted from the projector is directed in a manner that avoids obstruction and maximizes illumination efficiency.

One of the primary advantages of this outboard mounting configuration is the enhanced directionality of the light. When the projector is mounted in this manner, the pinch flange acts as a barrier that prevents light from scattering in unintended directions, such as towards the vehicle's undercarriage or back towards the pinch flange itself. Instead, the light is effectively redirected downwards, towards the ground, or at other specified angles. This precise control over the light projection not only improves visibility but also reduces glare and reflection that could otherwise interfere with the driver's vision or the visibility of the vehicle to others.

Furthermore, this assembly configuration can contribute to improved safety and functionality. By ensuring that the light is projected in the correct direction, the technology enhances the illumination of the road or surrounding environment, which is crucial for night driving or adverse weather conditions. This targeted lighting can help in highlighting obstacles, road signage, or other vehicles, thereby aiding in the driver's situational awareness. Additionally, it can be beneficial for aesthetic purposes, providing a cleaner and more focused lighting design that complements the vehicle's overall look.

In summary, the described technology offers a practical and effective solution for vehicle lighting systems by utilizing an outboard mounting assembly on the pinch flange. This approach not only optimizes the direction and effectiveness of light projection but also enhances safety and aesthetic appeal. By strategically redirecting light away from the vehicle's structural components and towards the desired areas, this technology addresses common challenges associated with vehicle lighting, making it a valuable innovation in automotive design.

Projector Integration, in accordance with one embodiment, the low-profile light assembly further comprises a projector (such as shown at 204 prior embodiments). This projector is operatively connected to the first light housing 804. The projector 204 is affixed to the vehicle body directly adjacent to pinch flange 802 or to the light housing 804 through the use of adhesive tape and/or an attachment piece 828, which is specifically designed to be at least partially received by a hole located within the vehicle undercarriage.

Attachment Mechanisms. In another embodiment, the attachment piece may be selected from a group consisting of a wingnut 832, a bolt 810, 812, 830, a clip, and/or a tether 834. These attachment mechanisms provide robust and versatile means for securing the light assembly to the vehicle structure.

Alternative Embodiments. The assembly also contemplates an alternative low-profile lighting concept that is designed to be mounted discreetly behind the pinch flange. This design aims to achieve a similar light distribution pattern to existing light bars, albeit with a more simplified structure. The lighting system may include a separate unit for projecting an image positioned forward of the light assembly's mounting location. The inventive aspect of this embodiment lies in its concealed positioning and the use of lensing technology to direct light effectively.

Construction and Features. The light assembly is environmentally sealed, utilizing a combination of adhesive and mechanical fasteners to ensure durability. It employs two LED PCBs oriented in opposing directions to optimize light control, accompanied by a driver PCB that provides electrical protection and manages voltage or current. Electrical connections may be established via soldered wires or alternative board-to-board connection methods, such as pins or electrical headers.

Optics and Housing. The lens system is designed to produce a linear biased light pattern, incorporating directing and light-shaping optics, material diffusion, and color-over-angle correction. The housing is constructed from cast metal, featuring apertures for light emission and sightlines, and functions as a protective enclosure against environmental hazards such as rocks and scrapes. Additionally, the housing serves as a heatsink, accommodating higher wattage LED configurations.

Reflector and Additional Features. The reflector may be fabricated from metalized or white material, configured to shape and enhance light output while increasing lamp efficiency through light recycling. It may be constructed as a symmetrical two-piece unit or a hinged single part. The housing integrates wire strain relief features, allowing for secure cable management with ties and corrugated tubing. The system is capable of daisy-chaining with a logo or functioning as a standalone unit. Integrated vehicle attachment features include options for mounting via tape and a wingnut through a drain hole, or utilizing a customizable attachment accessory, such as a wingnut, bolt, clip, or tether.

It is noted that the terms “substantially” and “about” may be utilized herein to represent the inherent degree of uncertainty that may be attributed to any quantitative comparison, value, measurement, or other representation. Any values that may be modified by such terminology are also part of the teachings herein. For example, if a teaching recited “about 10,” the skilled person should recognize that the value of 10 is also contemplated.

These terms are also utilized herein to represent the degree by which a quantitative representation may vary from a stated reference without resulting in a change in the basic function of the subject matter at issue.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

As used herein the terms “polymer” and “polymerization” are generic, and can include either or both of the more specific cases of “homo-” and copolymer” and “homo- and copolymerization”, respectively.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination. It is therefore intended that the appended claims (and/or any future claims filed in any Utility application) cover all such changes and modifications that are within the scope of the claimed subject matter.

What is claimed is:

1. A light projector assembly configured to connect to a light bar, comprising:
a projector having a longitudinal axis, wherein the projector is configured to rotatably couple to the light bar via an attachment item;
the projector being configured to rotate;
the projector having a projector aperture whereby light passes therethrough and directs onto a ground surface;
the projector being configured to receive a light housing, wherein the light housing is rotatably coupled to the projector;
the light housing being configured to rotate around an axis perpendicular to the longitudinal axis of the projector, the light housing being configured to rotate around an axis parallel to the longitudinal axis of the projector, wherein the light housing may be locked in a desired position relative to the projector via at least one locking mechanism;
the light housing comprising lens components, wherein the light housing is sealed so as to protect the projector and the lens components; and
the light housing being clear allowing light to pass therethrough.

2. The light projector assembly of claim 1, further comprising a lens stack, the lens stack configured to be installed at the end of manufacturing or post manufacturing.

3. The light projector assembly of claim 2, wherein the projector and the light bar share power and control wires from a wire harness.

4. The light projector assembly of claim 1, wherein the at least one locking mechanism may be a set screw, a locking wedge, a locking wedge with teeth, an angle wedge, a flat wedge, and/or a spring.

5. The light projector assembly of claim 1, wherein the attachment item is a bracket, a crimp, and/or a clamp.

6. The light projector assembly of claim 1, wherein the lens components comprise a collimation lens set, a zoom and aberration lens set, and/or an image slide with a preferred logo and/or pattern for projection onto a ground surface.

7. A connection assembly for connection to the body sheet metal of a vehicle, the connection assembly comprising:
a grommet configured to be partially received in an opening of the body sheet metal of a vehicle;
a light bar wire configured to be received within the grommet; and
a tether configured to couple the light bar wire to the body sheet metal of the vehicle.

8. The connection assembly of claim 7, wherein the grommet comprises a first portion partially received within the opening of the body sheet metal of the vehicle and having a first longitudinal axis substantially perpendicular to the body sheet metal, a second portion connected to the first portion and having a second longitudinal axis at an angle of approximately 45 degrees relative to the body sheet metal, and a third portion connected to the second portion and having a third longitudinal axis substantially parallel to the body sheet metal.

9. The connection assembly of claim 8, wherein a first portion of the light bar wire extends along the first longitudinal axis of the grommet, a second portion of the light bar wire extends along the second longitudinal axis of the grommet, and a third portion of the light bar wire extends along the third longitudinal axis of the grommet.

10. The connection assembly of claim 9, wherein the tether comprises:
a circular portion positioned around the first portion of the light bar wire and configured to connect to the first portion of the light bar wire; and
at least one arm configured to connect to the first portion of the light bar wire, the circular portion, and the body sheet metal.

11. The connection assembly of claim 9, wherein the first portion of the light bar wire comprises at least one extension arm extending away from the first longitudinal axis of the grommet.

12. The connection assembly of claim 11, wherein the tether comprises:
an interference portion positioned around the first portion of the light bar wire and having at least one opening around the circumference of the interference portion;
at least one arm configured to connect to the interference portion and the body sheet metal; and
wherein the at least one extension arm extends through the at least one opening in the interference portion to prevent movement of the interference portion relative to the body sheet metal along the first longitudinal axis of the grommet.

13. The connection assembly of claim 9, wherein the tether comprises:
a connector portion positioned around the first portion of the light bar wire and configured to connect to the first portion of the light bar wire via at least one intermediate arm; and
at least one arm configured to connect to the first portion of the light bar wire, the connector portion, and the body sheet metal.

14. The connection assembly of claim 9, wherein the tether comprises:
a sheath portion configured to be received in the grommet and positioned around the first, second, and third portions of the light bar wire and configured to connect to the first, second, and third portions of the light bar wire via at least one intermediate arm; and
at least one arm configured to connect to the sheath portion and the body sheet metal.

15. A low-profile light assembly for connection to the vehicle undercarriage, the light assembly comprising:
a pinch flange of a vehicle extending linearly between the fore and aft of the vehicle;
a light housing coupled to the vehicle undercarriage and directly adjacent to the pinch flange, and the light housing configured to direct light in the fore and aft directions.

16. The low-profile light assembly of claim 15, wherein a projector is provided connected to the light housing.

17. The low-profile light assembly of claim 15, wherein the projector couples to the vehicle undercarriage via tape and/or an attachment piece configured to be at least partially received by a hole in the vehicle undercarriage.

18. The low-profile light assembly of claim 15, wherein the first light housing is located between the pinch flange and a centerline of the vehicle, wherein the first light housing is hidden from view of a user outside of the vehicle.

19. The low-profile light assembly of claim 15, wherein the first light housing is located between the pinch flange and an outer perimeter of the vehicle so as to improve block excess light and/or reflect light towards the ground.

20. A light bar and integrated projector assembly, comprising:
a light bar;
a projector integrated within the light bar;
at least one bracket for supporting the light bar, the bracket being connected to the light bar through pre-formed holes;
a wire or wire harness connected to the projector and to the light bar for supplying power and signals;
the projector including at least one mirror or reflector positioned at an angle to direct projected light towards a specific area;
wherein the projector is axially aligned with the light bar, and the mirror or reflector is configured to redirect the light output towards a target area, thereby providing both illumination and projection capabilities in a single unit.
